(19) United States
(12) Patent Application Publication
(10) Pub. No.: US 2009/0124322 A1
(43) Pub. Date: May 14, 2009

(54) Wagering Game and Method Having A Multi-Progressive Feature

(75) Inventors: Loren T. Nelson, Reno, NV (US); Jeffrey Mincey, Reno, NV (US); Michael Delaney, Reno, NV (US)

Correspondence Address: BALLY GAMING INC., 6601 S. BERMUDA ROAD, LAS VEGAS, NV, 89119, US

(73) Assignee: Bally Gaming, Inc., Las Vegas, NV (US)

(21) Appl. No.: 12/256,391

(22) Filed: Oct. 22, 2008

Related U.S. Application Data
(60) Provisional application No. 60/987,297, filed on Nov. 12, 2007.

(51) Int. Cl. A63F 9/24; A63F 13/00

(52) U.S. Cl. 463/16; 463/20

(57) ABSTRACT

Disclosed are games, gaming machines, gaming systems and methods including a multi-progressive feature. During play of a feature game, tallies are kept of the appearance of various symbols. One or more progressive awards may be paid based on the tallies.

### RELATED APPLICATIONS

This application is a continuation of and claims priority from U.S. provisional patent application 60/987,297 filed on Nov. 12, 2007.

This application is also related to U.S. patent application Ser. No. ______ entitled “GAMING MACHINE AND METHOD HAVING A MULTI-PROGRESSIVE FEATURE,” filed on Oct. 22, 2008 which claims priority from provisional application 60/987,297 filed on Nov. 12, 2007.

This application is also related to U.S. patent application Ser. No. ______ entitled “NETWORKED GAMING SYSTEM AND METHOD HAVING A MULTI-PROGRESSIVE FEATURE,” filed on Oct. 22, 2008 which claims priority from provisional application 60/987,297 filed on Nov. 12, 2007.

All of the above referenced applications are hereby incorporated by reference in their entireties for all purposes.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention is directed to wagering games, gaming machines, networked gaming systems and methods and, more particularly, to wagering games, gaming machines, networked gaming systems and methods having a secondary game with multiple progressive awards.

2. Description of the Related Art

In the prior art, various types of gaming machines have been developed with different features to captivate and maintain player interest. In general, a gaming machine allows a player to play a game in exchange for a wager. Depending on the outcome of the game, the player may be entitled to an award which is paid to the player by the gaming machine, normally in the form of currency or game credits. Gaming machines may include flashing displays, lighted displays, or sound effects to capture a player's interest in a gaming device.

Another important feature of maintaining player interest in a gaming machine includes providing the player with many opportunities to win awards, such as cash or prizes. For example, in some slot machines, the display windows show more than one adjacent symbol on each reel, thereby allowing for multiple-line betting. Feature games of various types have been employed to reward players above the amounts normally awarded on a standard game pay schedule. Generally, such feature games are triggered by predetermined events such as one or more appearances of certain combinations of indicia in a primary game. In order to stimulate interest, feature games are typically set to occur at a gaming machine on a statistical cycle based upon the number of primary game plays.

Some gaming machine games today include one or more progressive prize awards. In some configurations, the progressive prize may have a small probability of a player winning it; thus making it possible to have a larger progressive prize. In other game configurations, the progressive prize may be a small amount; thus allowing the player patron to win the progressive prize more frequently. In most typical game configurations, the player wins the progressive prize as a result of a specific game outcome within the primary or main game.

While gaming machines including feature games and progressive prizes have been very successful, there remains a need for games that provide a player with enhanced excitement and increased opportunity of winning

### SUMMARY OF THE INVENTION

In accordance with one or more embodiments of the invention, a wagering game includes an interface activatable by a player and a first game comprising one or more game plays, at least one of the game plays occurring after activation of the interface by the player. A second game is associated with the first game, the second game including a plurality of second game plays, each second game play having an outcome and a plurality of accumulators, each associated with an icon, for tallying second game outcomes containing one or more of the icons. One or more awards may be won based on the value of one or more of the accumulators at the conclusion of the plurality of second game plays. In accordance with one or more embodiments of the invention, one or more of the awards may be a progressive award.

In accordance with other embodiments of the invention, a method of operating a game includes the steps of accepting a wager from a player and initiating play of a first game according to the wager. Upon the occurrence of a triggering event associated with the first game, the method further includes the step of initiating play of a second game, where the second game includes a plurality of second game plays, each second game play having an outcome which may include one or more icons. The method also includes the steps of tallying the second game outcomes including one or more of the icons and awarding one or more awards which may be won according to the tally.

Other features and advantages will become apparent from the following detailed description, taken in conjunction with the accompanying drawings, which illustrate by way of example, the features of the various embodiments.

### BRIEF DESCRIPTION OF THE DRAWINGS

FIG. 1 is a perspective view of a gaming machine in accordance with one aspect of the present invention.

FIG. 2 is a block diagram of the physical and logical components of the gaming machine of FIG. 1.

FIG. 3 provides an overview of a game of one embodiment of the invention.

FIG. 4 is a display image associated with a help screen of one embodiment of the invention.

FIG. 5 is a display image associated with an example feature game in accordance with one or more embodiments of the invention.

FIG. 6 is a display image associated with an example feature game in accordance with one or more embodiments of the invention.

FIG. 7 is a functional block diagram depicting the steps associated with carrying out an example method in accordance with one or more aspects of the invention.

FIG. 8 is a schematic block diagram showing the hardware elements of a networked gaming system in accordance with one or more aspects of the present invention.

### DETAILED DESCRIPTION OF THE PREFERRED EMBODIMENTS

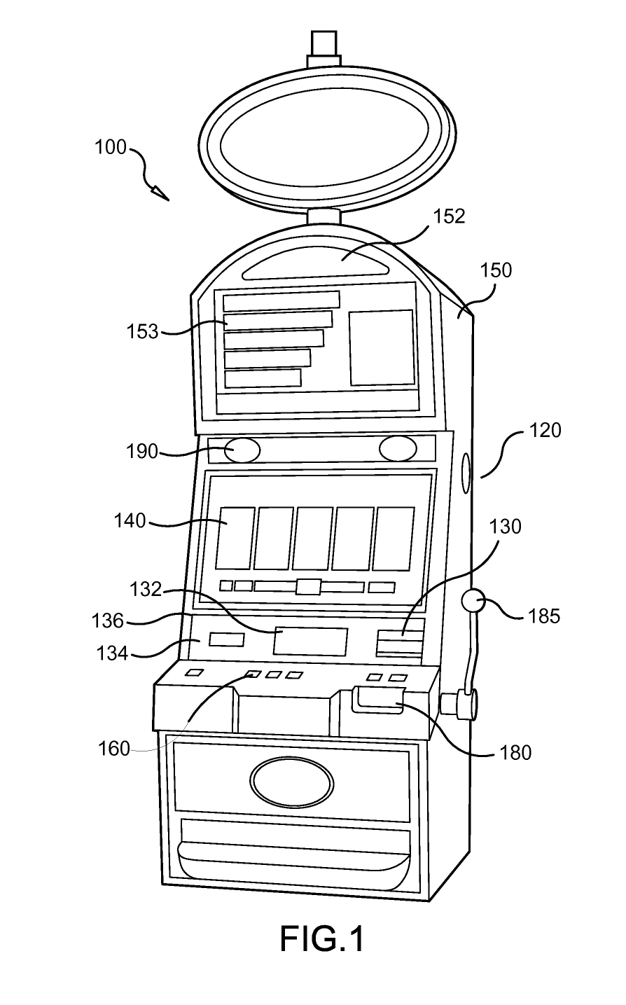

Various embodiments are directed to a game, gaming machine, gaming networks and method for playing a game, wherein the game includes a multi-progressive secondary game. The embodiments are illustrated and described herein, by way of example only, and not by way of limitation. Referring now to the drawings, and more particularly to FIGS. 1-7, there are shown illustrative examples of games, gaming machines, gaming networks and methods for playing a game in accordance with various aspects of the invention.

In accordance with one or more embodiments, FIG. 1 illustrates a gaming machine 100 including cabinet housing 120, primary game display 140 upon which a primary game and feature game may be displayed, top box 150 which may display multiple progressives that may be won during play of the feature game, player-activated buttons 160, player tracking panel 136, bill/voucher acceptor 180 and one or more speakers 190. Cabinet housing 120 is a self-standing unit that is generally rectangular in shape and may be manufactured with reinforced steel or other rigid materials which are resistant to tampering and vandalism. Cabinet housing 120 houses a processor, circuitry, and software (not shown) for receiving signals from the player-activated buttons 160, operating the games, and transmitting signals to the respective displays and speakers. Any shaped cabinet may be implemented with any embodiment of gaming machine 100 so long as it provides access to a player for playing a game. For example, cabinet 120 may comprise a slant-top, bar-top, or table-top style cabinet. The operation of gaming machine 100 is described more fully below.

The plurality of player-activated buttons 160 may be used for various functions such as, but not limited to, selecting a wager denomination, selecting a game to be played, selecting a wager amount per game, initiating a game, or cashing out money from gaming machine 100. Buttons 160 function as input mechanisms and may include mechanical buttons, electromechanical buttons or touch screen buttons. Optionally, a handle 185 may be rotated by a player to initiate a game.

In other embodiments, buttons 160 may be replaced with various other input mechanisms known in the art such as, but not limited to, a touch screen system, touch pad, track ball, mouse, switches, toggle switches, or other input means used to accept player input. For example, one input means is a universal button module as disclosed in U.S. application Ser. No. 11/106,212, entitled “Universal Button Module,” filed on Apr. 14, 2005, which is hereby incorporated by reference. Generally, the universal button module provides a dynamic button system adaptable for use with various games and capable of adjusting to gaming systems having frequent game changes. More particularly, the universal button module may be used in connection with playing a game on a gaming machine and may be used for such functions as selecting the number of credits to bet per hand.

Cabinet housing 120 may optionally include top box 150 which contains “top glass” 152 comprising advertising or payout information related to the game or games available on gaming machine 100. Player tracking panel 136 includes player tracking card reader 134 and player tracking display 132. Voucher printer 130 may be integrated into player tracking panel 136 or installed elsewhere in cabinet housing 120 or top box 150.

Game display 140 presents a game of chance wherein a player receives one or more outcomes from a set of potential outcomes. For example, one such game of chance is a video slot machine game. In other aspects of the invention, gaming machine 100 may present a video or mechanical reel slot machine, a video keno game, a lottery game, a bingo game, a Class II bingo game, a roulette game, a craps game, a blackjack game, a mechanical or video representation of a wheel game or the like.

Mechanical or video/mechanical embodiments may include game displays such as mechanical reels, wheels, or dice as required to present the game to the player. In video/mechanical or pure video embodiments, game display 140 is, typically, a CRT or a flat-panel display in the form of, but not limited to, liquid crystal, plasma, electroluminescent, vacuum fluorescent, field emission, or any other type of panel display known or developed in the art. Game display 140 may be mounted in either a “portrait” or “landscape” orientation and be of standard or “widescreen” dimensions (i.e., a ratio of one dimension to another of at least 16×9). For example, a widescreen display may be 32 inches wide by 18 inches tall. A widescreen display in a “portrait” orientation may be 32 inches tall by 18 inches wide. Additionally, game display 140 preferably includes a touch screen or touch glass system (not shown) and presents player interfaces such as, but not limited to, credit meter (not shown), win meter (not shown) and touch screen buttons (not shown). An example of a touch glass system is disclosed in U.S. Pat. No. 6,942,571, entitled “Gaming Device with Direction and Speed Control of Mechanical Reels Using Touch Screen,” which is hereby incorporated by reference.

Game display 140 may also present information such as, but not limited to, player information, advertisements and casino promotions, graphic displays, news and sports updates, or even offer an alternate game. This information may be generated through a host computer networked with gaming machine 100 on its own initiative or it may be obtained by request of the player using either one or more of the plurality of player-activated buttons 160; the game display itself, if game display 140 comprises a touch screen or similar technology; buttons (not shown) mounted about game display 140 which may permit selections such as those found on an ATM machine, where legends on the screen are associated with respective selecting buttons; or any player input device that offers the required functionality.

Cabinet housing 120 incorporates a single game display 140. However, in alternate embodiments, cabinet housing 120 or top box 150 may house one or more additional displays 153 or components used for various purposes including additional game play screens, animated “top glass,” progressive meters or mechanical or electromechanical devices (not shown) such as, but not limited to, wheels, pointers or reels. The additional displays may or may not include a touch screen or touch glass system.

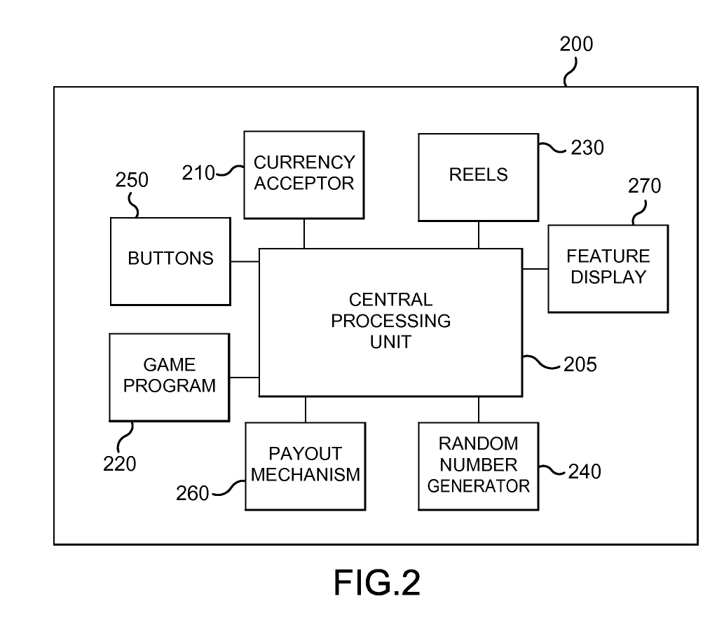

In accordance with one embodiment of the present invention, FIG. 2 is a block diagram showing the interconnection 200 of physical and logical components of gaming machine 100. Currency acceptor 210 is typically connected to a conventional central processing unit (“CPU”) 205, such as an Intel Pentium microprocessor mounted on a gaming motherboard, by a serial connection such as RS-232 or USB. The gaming motherboard may be mounted with other conventional components, such as are found on conventional personal computer motherboards, and loaded with a gaming machine operating system (OS), such as an Alpha OS installed within a Bally S9000, M9000 or CineVision™ slot machine. CPU 205 executes game program 220 that causes reels 230 to display a game. In one embodiment, game program 220 is a slot machine game having a multi-progressive feature game.

When a player has inserted a form of currency such as, for example and without limitation, paper currency, coins or tokens, cashless tickets or vouchers, electronic funds transfers or the like into currency acceptor 210, a signal is sent to CPU 205 which, in turn, assigns an appropriate number of credits for play. The player may further control the operation of the gaming machine, for example, to select the amount to wager via electromechanical or touch screen buttons 250. The game starts in response to the player pushing one of buttons 250 or an alternate start mechanism such as a handle or touch screen icon (not shown). Random number generator 240 responds to instructions from CPU 205 to provide a display of randomly selected indicia on reels 230. In some embodiments, random generator 240 may be physically separate from gaming machine 100; for example, it may be part of a central determination host system (not shown) which provides random game outcomes to CPU 205. Thereafter, the player may or may not interact with the game through electromechanical or touch screen buttons 250 to change the displayed indicia. Finally, CPU 205 under control of game program 220 compares the final display of indicia to a pay table. The set of possible game outcomes may include a subset of outcomes related to the triggering of a feature game. In the event the displayed outcome is a member of this subset, CPU 205, under control of game program 220, may cause feature game play to be presented on feature display 270.

In one embodiment, reels 230 are electromechanical reels. Game program 220 includes reel spinning firmware to provide proper signals for driving multiple stepper motors (not shown), which, in turn, spin the reels 230. Preferably, the motors are driven using a “full step” excitation sequence in which a single motor step is preformed by changing the excitation on one of the two-phase inputs in a specified sequence. The sequence determines whether the direction implemented is forward or reverse. The reel drive pulse trains go through three distinct stages: acceleration, steady state, and deceleration. During acceleration, reels 230 are driven with a pulse frequency that is less than the maximum “start/stop” frequency. Typically, if a motor is attempted to be started with a high frequency pulse, the motor loses synchronization and slips. Therefore, preferably the drive frequency is incrementally increased until the steady state drive frequency is reached. At steady state, reels 230 are driven for a specified number of steps at the maximum drive frequency before going to the deceleration phase. During deceleration, the process is reversed and the drive frequency decreased until the stopping frequency is reached. Preferably, this procedure helps to prevent reels 230 from slipping past the proper stop position on deceleration. Finally, at the stopping point, the motor excitation signals are held constant.

In one embodiment, the primary game reels are not used for the feature play; instead, a wheel or other feature display 270 is used to present the feature game outcomes. The feature display may be an electromechanical device, may present the feature on a video display or both.

Predetermined payout amounts for certain outcomes, including feature game outcomes, are stored as part of game program 220. Such payout amounts are, in response to instructions from CPU 205, provided to the player in the form of coins, credits or currency via payout mechanism 260, which may be one or more of a credit meter, a coin hopper, a voucher printer, an electronic funds transfer protocol or any other payout means known or developed in the art.

In various embodiments of gaming machine 100, game program 220 is stored in a memory device (not shown) connected to or mounted on the gaming motherboard. By way of example, but not by limitation, such memory devices include external memory devices, hard drives, CD-ROMs, DVDs, and flash memory cards. In an alternative embodiment, the game programs are stored in a remote storage device. In one embodiment, the remote storage device is housed in a remote server. The gaming machine may access the remote storage device via a network connection, including but not limited to, a local area network connection, a TCP/IP connection, a wireless connection, or any other means for operatively networking components together. Optionally, other data including graphics, sound files and other media data for use with gaming machine 100 are stored in the same or a separate memory device (not shown). Some or all of game program 220 and its associated data may be loaded from one memory device into another, for example, from flash memory to random access memory (RAM).

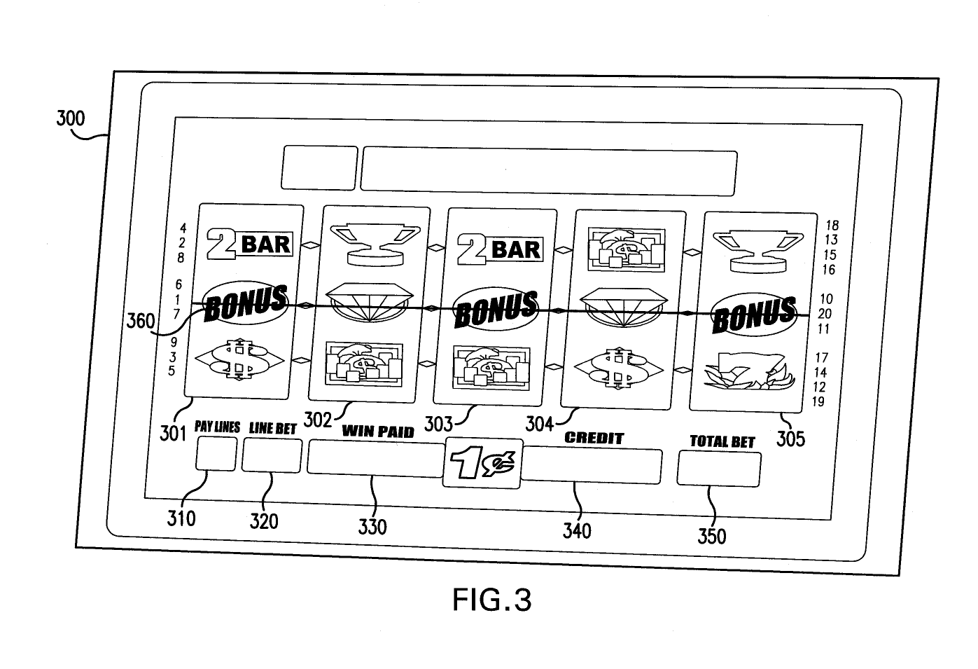

An example game in accordance with one or more aspects of the invention is shown in FIGS. 3-5. Referring to FIG. 3, game 300 is implemented using five spinning reels 301-305. Each of 30 pay line patterns (not shown) passes through one indicium on each of the five reels. For example, the first pay line 360 extends horizontally through the center position of each of the five reels 301-305. The number of pay lines and their patterns are by way of example only and may vary. The player selects the number of played pay lines and the number of credits or coins wagered on each line using touch screen controls or gaming device control buttons. The player's selections are displayed on PAY LINES meter 310, LINE BET meter 320 and TOTAL BET meter 330 located adjacent to the reels. WIN PAID meter 340 and CREDIT meter 350 provide the player with information about the amount paid by the last game played and the total number of credits available for play. The player may collect the balance of his credits by pressing a COLLECT button (not shown).

The player initiates game play by pressing a SPIN button (not shown). In some embodiments, the player may simultaneously select all pay lines at the maximum number of coins or credits allowed per line by pressing a MAX BET button. Buttons (see FIG. 1, 160) on gaming machine 100 (FIG. 1) or touch screen buttons (not shown) may be used to perform the actions described here without deviating from the scope of the invention. Reels 301-305 are made to spin and stop in predetermined stop positions. A determination is then made whether the stop positions of the reels resulted in a winning game outcome.

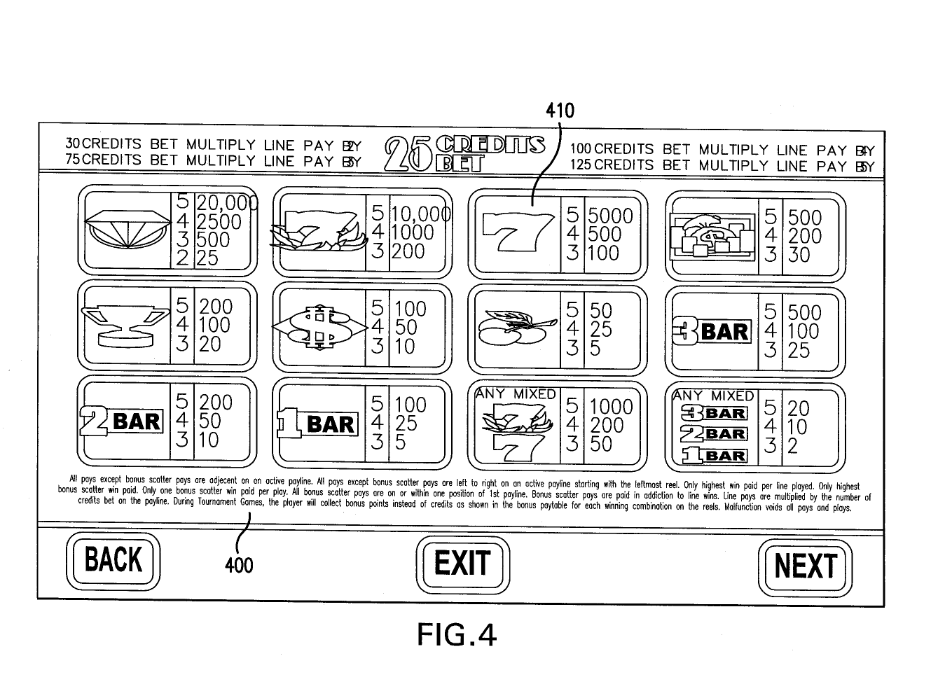

In accordance with one embodiment, part of an example pay table 400 is shown in FIG. 4. The pay table may be accessible through a HELP/PAYS or similar button. In alternate embodiments, the pay table may be presented on a second video or printed display attached to the gaming device (i.e. display 153 or “pay glass” 152, FIG. 1). A winning combination, for example, could be three or more symbols adjacent to one another on an active pay line. For each winning combination, the game device awards the player the award in the pay table, adjusted as necessary based on the number of credits wagered on the pay line on which the win occurred. For example, three RED 7 symbols 410 adjacent to one another from left-to-right on an active pay line would pay 100 times the player's wager. In some embodiments, video representations of pay tables may factor in the amount of the player's wager and no additional award adjustment is required.

In various embodiments, winning combinations may be evaluated across adjacent reels from left-to-right, from right-to-left or both. Additional winning combinations may be awarded when certain indicia do not necessarily accumulate adjacently on a pay line, but rather, appear anywhere on the reels (i.e., “scatter pays”). In addition, “wild” indicia may be used to complete winning combinations. Some “wild” indicia may also cause completed winning combinations to result in pay amounts in excess of the normal winning combination by way of multiplication or addition, for example, a wild doubler symbol may be used.

Various primary game outcomes may be utilized to trigger the play of a feature game, including, but not limited to, awarding feature play when certain symbols appear on a pay line, when certain symbols are scattered, when no symbols of a certain type appear, when a certain winning combination occurs or, regardless of the visible symbols, at random or fixed intervals. The availability of the feature game may be restricted based on the size of the wager.

In some embodiments, the feature game may be one of a set of primary games randomly selected for play following initiation of play by the player. For example, multiple primary games are disclosed in U.S. application Ser. No. 11/428,220, entitled “Multiple Primary Games Triggered by Random Number Generator,” filed on June 30, 2006, which is hereby incorporated by reference, in which a gaming machine has at least two distinct primary games. After receiving a wager, the gaming machine determines which primary game to activate. The selected primary game is activated and a game outcome is presented to the player on a game display. A payout may be awarded according to the game outcome. The availability of the game may be restricted based on the size of the wager.

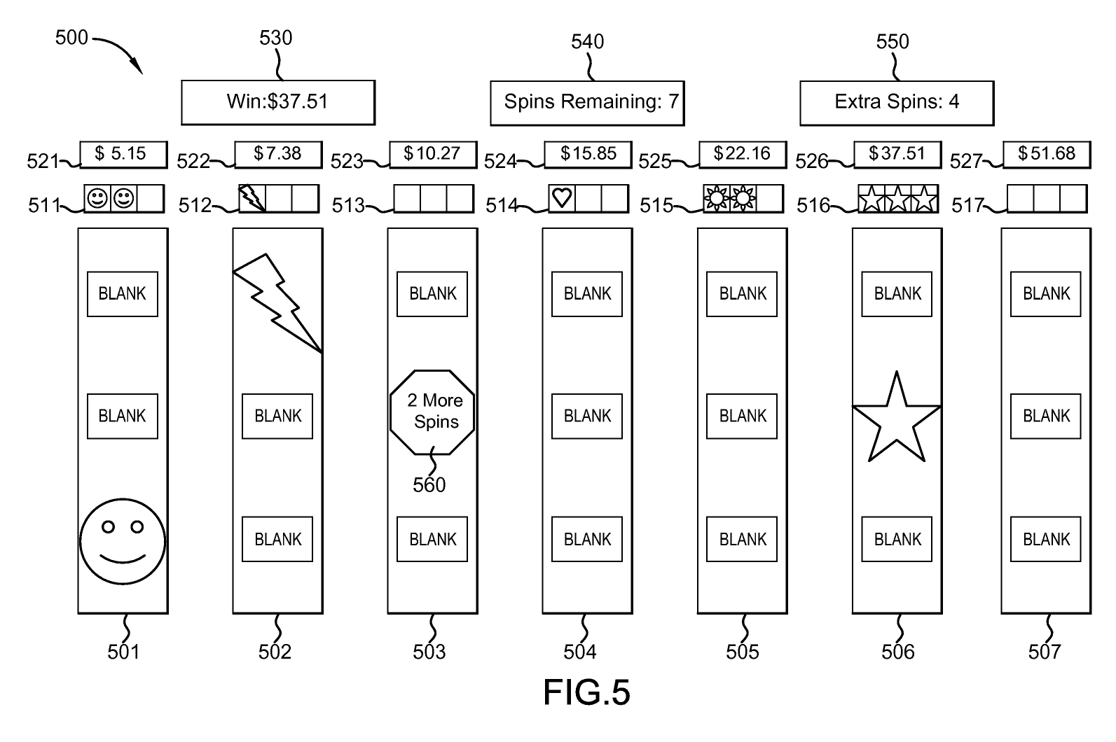

Referring to FIG. 5, in accordance with one or more embodiments of the invention, display 500 presents an example screen from a feature game in which a player may win one or more progressive prizes 521-527. In one or more embodiments, the player is given the opportunity to play multiple free games of a spinning reel slot-based game after the occurrence of a triggering event which may conventionally comprise a pre-determined result on the base game. Meter 540 displays the number of remaining free games throughout the course of feature game play. Meter 530 displays the total amount won during feature game play. Within the feature game, there are one or more spinning reels 501-507, where each reel has an associated progressive prize 521-527. Each reel 501-507 also has an associated counter or scoring mechanism 511-517. Upon completion of each free game, the resulting outcome has the possibility of the player collecting or scoring one or more units associated with each reel 501-507, the results may be respectively accumulated and displayed as shown with respect to scoring mechanism 511-517. Each reel 501-507 contains one or more symbols, with at least one symbol associated with the collecting or scoring of one or more units associated with that reel. In some embodiments, some reels contain symbols 560 which award the player additional free spins. The number of extra free games awarded during play of the feature are tallied and displayed by meter 550. In one or more embodiments, scoring three units for one or more reels wins the progressive prize 521-527 associated with that reel or reels. The number of units required in order to win a progressive prize is an example and may vary. In one embodiment, a consolation award may be given to the player if no progressive prize was won within the allotted number of free spins. This consolation award may be a fixed amount relative to the initiating bet, or it may be based on the number of units scored during the free spins, or a combination thereof. In an alternate embodiment, the number of free spins is not limited and the player is allowed to play as many free spins as necessary to win at least one of the progressive prizes.

While the above example associates symbols to be tallied and the respective progressive prizes with individual reels, in accordance with one or more embodiments, the tallies may be associated with the number of symbols appearing on one or more pay lines, within a particular subset of reels, in a particular position or set of positions, or otherwise appearing so as to be tallied.

In accordance with still other embodiments, eligibility to win one or more of the progressives may be based on the size of the player's wager. For example, a single coin wager may make the player eligible to win a first progressive according to its tally, while a two-coin wager might make the player eligible to win both the first progressive and a second progressive. Generally, the more the player wagers, the more opportunities to win a progressive will be enabled.

In accordance with one or more embodiments of the invention, the progressive prizes 521-527 may be calculated by a progressive controller such as a controller manufactured by Mikohn, Inc. The progressive controller monitors wagering during base game play, calculates a current value for one or more progressive jackpot pools and transmits the current pool values to the gaming machine. In one or more embodiments, progressive awards are accumulated during regular play as a percentage, such as three percent, of the game play take. The prizes may be sized according to the preferences of the casino operator. The number of prizes may vary without deviating from the scope of the invention. The size of the prizes is dependent on the amount of play prior to initiating feature play and may come from the contributions of a single gaming machine or a number of linked gaming machines. In another aspect, the prizes may be set amounts established by the casino operator from non-coin-in funds, such as marketing funds.

In one or more embodiments, the prizes for feature game play may be accumulated based on funding mechanisms other than a percentage of wagers accumulated by the gaming machine. For example, an operator may initially fund the various award levels such as are shown in FIG. 5 with a pre-determined amount of money, such as $1000 for one progressive, $500 for a second progressive, $100 for a third progressive and so on. Subsequently, the casino operator may determine to increase the amounts of one or more of the awards at pre-determined times which may be periodically or randomly selected with a range of times or periods. Once a winner has occurred at any level, the award levels may be rolled back to the initial funding level. In one or more embodiments, only the winning award level is rolled back to the initial funding level.

In one or more embodiments, the prizes for feature game play may be set amounts, i.e. non-progressive. In one or more embodiments, the algorithms to determine the amounts may be determined by a statistical percentage based on an average take of a gaming machine and the likelihood of the win over a period of time. In the case where one or more gaming machines are networked, a common award table may be utilized where the award algorithms are determined based on an average take (total wagers) of all the networked gaming machines and the likelihood of a win of an award over a period of time. Each award may be calculated in a similar manner based on the likelihood of a winning outcome being achieved during a game play session.

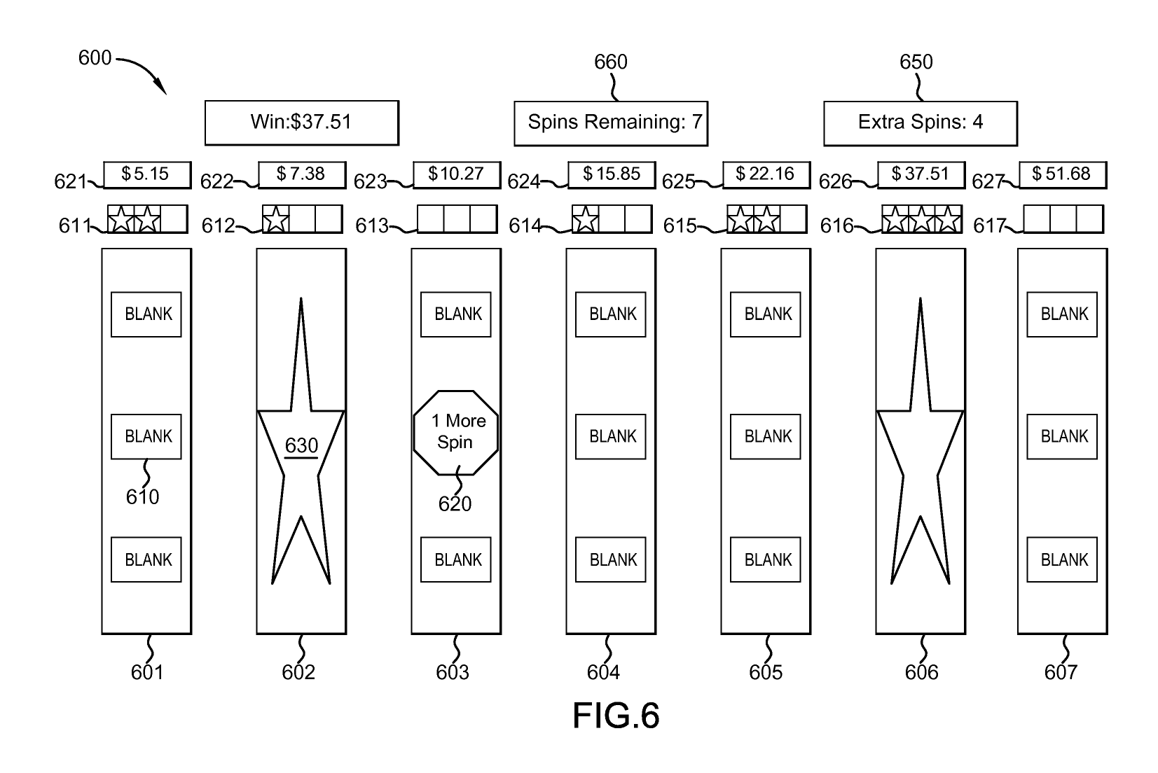

In accordance with one or more embodiments, a triggering event in a primary game initiates a feature game. The game transitions to a seven-reel slot game as illustrated by FIG. 6. Each reel 601-607 has three types of symbols; blank 610, extra spin 620, and star 630. The blank symbol 610, also known as a ghost, is just empty space between visible symbols. The extra spin symbol 620, when visible, will give the player additional spins for more chances to win. The star symbol 630 has a unique color associated with each reel 601-607 and is the size of the entire visible portion of the reel. Associated with each reel 601-607 is a counter or scorecard 611-617 to keep track of when a star symbol 630 appears on the reel after each spin of the game. A meter associated with each reel 601-607 indicates the value of a progressive award 621-617.

The player is allowed to play as many free games as necessary to win one of the progressive prizes. From the results of each free game, each extra spin symbol that is wholly visible in a reel, increments an extra spin counter 650. Each star symbol 630 that is wholly visible in a reel is scored in the scorecard 611-617 associated with that reel. When at least one reel scores its third star symbol 630, the player is awarded the progressive prize 621-627 associated with that reel. At this point the free games continue, limited by extra spin symbols that have accumulated in meter 650 thus far. These extra spins allow the player to win additional progressive prizes 621-627 once a progressive prize 621-627 has been won. In one or more embodiments, extra spins are no longer accumulated once a first progressive prize 621-627 is won. In still other embodiments, once a progressive prize 621-627 is won, the player may no longer win further prizes on its associated reel for the duration of the current bonus game. Once all of the extra spins indicated on extra spin counter 650 are exhausted, play returns to the primary game.

In one or more alternate embodiments, the player may be allowed only a fixed number of free games 660 in an attempt to win one or more of the progressive prizes 621-627. From the results of each free game, each extra spin symbol 620 that is wholly visible in a reel may also increase the number of spins allowed. Extra spins are tracked in extra spin counter 650, as described above. In some embodiments, if no progressive prize has been won when all allowed spins have been exhausted, a consolation prize may be awarded to the player. In a further alternate embodiment, all unused spins are forfeited once a progressive prize is won, and play returns to the primary game.

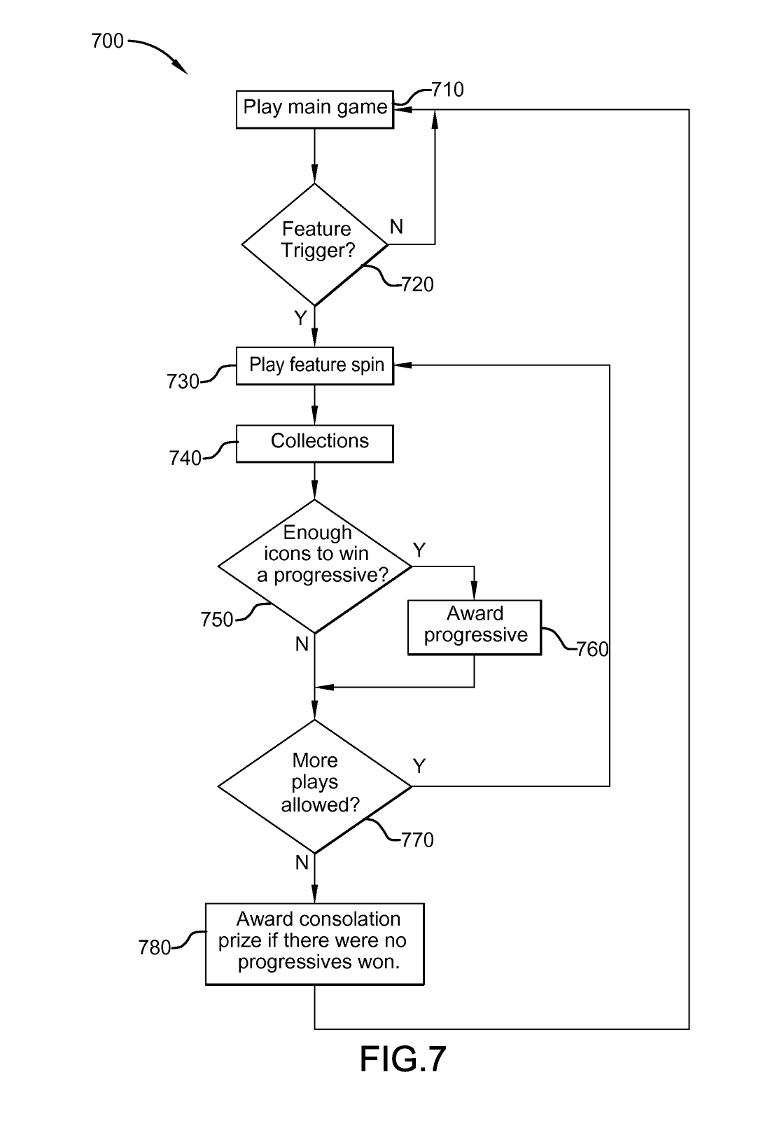

A logical flow diagram generally depicting the steps associated with a method 700 for carrying out a game having a multi-progressive feature, in accordance with one aspect of the invention, is presented in FIG. 7. The order of actions as shown in FIG. 7 is only illustrative, and should not be considered limiting. For example, the order of the actions may be changed, additional steps may be added or some steps may be removed without deviating from the scope and spirit of the invention.

First at block 710, a primary game play is played by a player as described above. In one embodiment, the player places a wager and starts the game, whereby each reel then spins or displays a representation of a slot machine reel spin before stopping with particular indicia displayed to the player. A win occurs if a series of indicia (BAR, BAR, BAR, for example) appears on one or more pay lines or scattered, as described above. The player is paid for any winning symbol combinations. At block 720, the indicia on the reels are examined to determine the existence of a combination predetermined to be a feature game trigger. For example, a BONUS symbol appearing scattered on the first, third and fifth reels may be considered a feature game trigger. If the displayed indicia do not correspond to a feature game trigger, processing resumes at block 710 with play of another iteration of the primary game. Otherwise, the feature game is played at blocks 730-780.

At block 730, the player plays a feature game including a slot machine game similar to the example games of FIGS. 5 and 6 above. The reels spin and stop to indicate a combination of feature game indicia.

At block 740, visible indicia corresponding to the collectible icons which may lead to the winning of a progressive prize are accumulated and displayed in one or more scorecards, as described above.

At block 750, each scorecard is examined to determine whether it is full. If so, the corresponding progressive prize is paid at block 760.

At block 770, a determination is made whether any feature game spins remain to be performed. For example, at the start of the feature game, it may have been determined that five reel spins would be performed. It will be appreciated that the number of reel spins may vary based on the rules of a particular embodiment, including, for example, a number of spins randomly selected during game play. In addition, the player may have accumulated extra spins as a result of feature game outcomes.

If all free reel spins have not been performed, flow return to block 730 to perform another feature spin, otherwise the feature game is complete. If the player has not yet won a progressive prize, a consolation prize may be awarded at block 780.

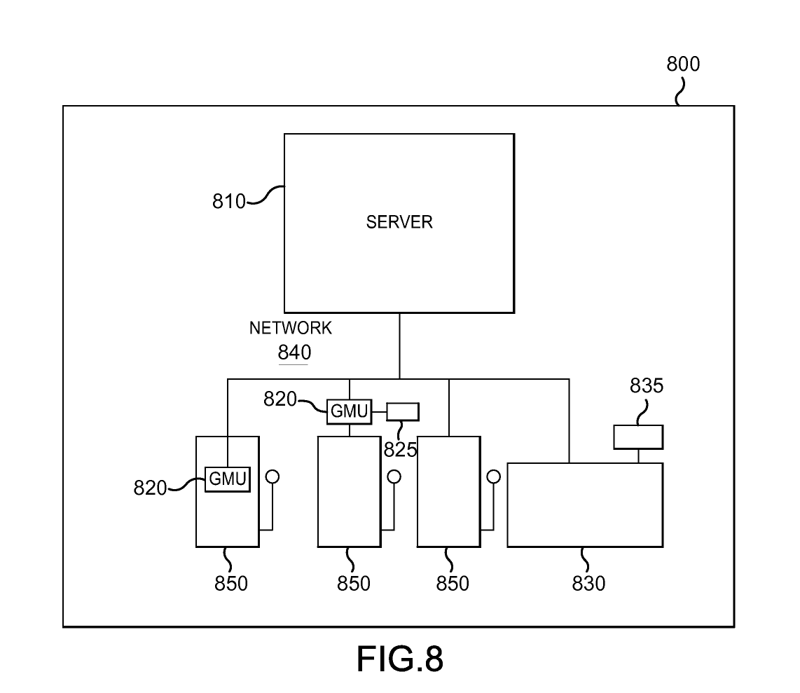

Referring to FIG. 8, in accordance with one or more aspects of the invention, a networked gaming system 800 includes server 810, gaming machines 850, and network 840 connecting gaming machines 850 to server 810. Additionally, gaming machine 850 are shown connected to group gaming controller 830 and progressive controller 860 as described in FIG. 2. Server 810 may be selected from a variety of conventionally available servers. The type of server used is generally determined by the platform and software requirements of the gaming system. Examples of suitable servers are an IBM RS6000-based server, an IBM AS/400-based server or a Microsoft Windows-based server, but it should be appreciated that any suitable server may be used. It may also be appreciated that server 810 may be configured as a single “logical” server that comprises multiple physical servers. Gaming machines 850 operate similar to conventional peripheral networked terminals. Gaming machines 850 have a player interface such as a display, a card reader, and selection buttons through which gaming machines 850 interact with a player playing a group game in accordance with various embodiments of the invention. The player interface is used for making choices such as the amount of a bet or the number of lines to bet. Gaming machines 850 also provide information to server 810 concerning activity on gaming machines 850 and provide a communication portal for players with server 810. For example, the player interface may be used for selecting different server-related menu options such as, but not limited to, transferring a specified number of credits from a player account onto the credit meter of the gaming machine, or for transferring credits from the gaming machine to a central player account.

In various embodiments, any of the gaming machines 850 may be a mechanical reel spinning slot machine, video slot machine, video poker machine, keno machine, video blackjack machine, or a gaming machine offering one or more of the above described primary games including a group play game. Alternately, gaming machines 850 may provide a group game as one of a set of multiple primary games selected for play by a random number generator, as described above. Networking components (not shown) facilitate communications across network 840 between the system server 810 and game management units 820 and/or gaming display control computers 830 that control displays for carousels of gaming machines. Game management units (GMU's) 820 connect gaming machines to networking components and may be installed in the gaming machine cabinet or external to the gaming machine. The function of the GMU is similar to the function of a network interface card connected to a desktop personal computer (PC) and it may contain tracking software which provides notification to the casino of certain events on a gaming machine 850, including wins. Depending upon the casino management system, payouts on large wins at gaming machines 850 may be made directly to a player account managed by the host computer; in which case, the player is notified by way of the GMU at gaming machine 850 that the player's account has been credited.

Some GMU's have much greater capability and can perform such tasks as presenting and playing a game for an individual player and/or in a group gaming environment where the game may be presented using one or more of the displays of the gaming machine, such as display 825 operatively connected to GMU 820. In one embodiment, GMU 820 is a separate component located outside the gaming machine. Alternatively, in another embodiment, the GMU 820 is located within the gaming machine. Optionally, in an alternative embodiment, one or more gaming machines 850 connect directly to the network and are not connected to a GMU 820. Displays related to group games played on gaming machines 850 or GMU displays 825 may also be presented on gaming display 835 by group gaming controller 830. Group gaming controller is also shown connected to network 840, through which is may be capable of receiving reconfigured displays for presentation on display 835. A gaming system of the type described above also allows a plurality of games in accordance with the various embodiments of the invention to be linked under the control of server 810 for cooperative or competitive play in a particular area, carousel, casino or between casinos located in geographically separate areas.

By example, in one or more embodiments, the software to execute the primary and/or feature game described above may be stored within the gaming machine and operable through a processor of the GMU and the game display as discussed above may be driven either through a display 825 or through one or more of the other gaming machine displays, such as displays 140, 153. In other alternative embodiments, the software to execute the primary and/or feature game may reside on a server, such as server 810, and the primary and/or feature game may be executed through a server processor which in turn may drive the images displayed at the gaming machine through one or more of the gaming machine displays. In one or more of said embodiments, one or more gaming machines 850 may be connected through a wireless network connecting to server 810 and/or other gaming machines 850. A wireless gaming machine may comprise a tablet or laptop computing device, a cell phone, a personal data device, etc.

In yet another embodiment, a trigger for group gaming may initiate the feature game for two or more eligible gaming machines 850. The trigger may be the feature game trigger discussed above or may be another combination of symbols. In the case of a group feature game, each player may accumulate symbols on their respective machines as discussed above and may accumulate wins of progressive awards as discussed above. In addition, at the end of the group feature game session, one or more players may receive additional awards based on their respective accumulated points or awards with respect to the other players.

The various embodiments described above are provided by way of illustration only and should not be construed to limit the claimed invention. For example, it may further be appreciated that each of the games could be operated on a remote host computer such that a player initiates play with the host computer over a network via the player interface and each gaming machine operates the respective gaming and video displays in conjunction with the game whose play is controlled by the remote computer. In another embodiment, a game in accordance with one or more aspects of the invention may be associated with a table game such a poker or blackjack. For example, a player may receive a chance to win a number of reel spins on a slot machine located adjacent the table, the opportunity based on cards or hands received during play of the table game. Each reel spin provides an opportunity to win a progressive according to the icons earned by way of the reel spins as described above.

Those skilled in the art will readily recognize various modifications and changes that may be made to the claimed invention without following the example embodiments and applications illustrated and described herein, and without departing from the true spirit and scope of the claimed invention, which is set forth in the following claims.

What is claimed:

1. A wagering game comprising:
an interface activatable by a player;
a first game comprising one or more game plays, at least one of the game plays occurring after activation of the interface by the player,
a second game associated with the first game, the second game comprising a plurality of second game plays, each second game play having an outcome;
a plurality of accumulators, each associated with an icon, for tallying second game outcomes containing one or more of the icons; and
one or more awards which may be won based on the value of one or more of the accumulators at the conclusion of the plurality of second game plays.

2. The game of claim 1 wherein one or more of the awards comprises a progressive prize.

3. The game of claim 2 further comprising a wager, wherein the progressive prize is at least partially funded based on a percentage of the wager.

4. The game of claim 2 wherein the progressive prize is not based on a percentage of the wager.

5. The game of claim 2 wherein all progressive prizes which may be won are reset to an initial funding level upon the winning of any one progressive prize.

6. The game of claim 1 further comprising one or more reels associated with the second game.

7. The game of claim 6 wherein one or more of the awards comprises a progressive prize associated with at least one of a reel, a set of reels or a pay line.

8. The game of claim 1 further comprising a wager, wherein play of the second game is restricted by an amount of the wager.

9. The game of claim 1 wherein the first game comprises at least one of a slot machine game, a poker game, a keno game, a blackjack game, a bingo game, and a roulette game and a wheel game.

10. The game of claim 1 wherein the game is associated with a table game.

11. A method of operating a game comprising the steps of:
accepting a wager from a player;
initiating play of a first game according to the wager;
upon a triggering event associated with the first game, initiating play of a second game, the second game comprising a plurality of second game plays, each second game play having an outcome which may comprise one or more icons;
tallying second game outcomes comprising one or more of the icons; and
awarding one or more awards which may be won according to the tally.

12. The method of claim 11 wherein at least one of the awards comprises a progressive prize.

13. The method of claim 12 wherein the progressive prize is at least partially funded based on a percentage of the wager.

14. The method of claim 12 wherein the progressive prize is not based on a percentage of the wager.

15. The method of claim 12 wherein all progressive prizes which may be won are reset to an initial funding level upon the winning of any one progressive prize.

16. The method of claim 11 further comprising one or more reels associated with the second game.

17. The method of claim 16 wherein one or more of the awards comprises a progressive prize associated with at least one of a reel, a set of reels or a pay line.

18. The method of claim 11 wherein play of the second game is restricted by an amount of the wager.

19. The method of claim 11 wherein the first game comprises at least one of a slot machine game, a poker game, a keno game, a blackjack game, a bingo game, and a roulette game and a wheel game.

20. The method of claim 11 wherein the first game is associated with a table game.
